(19) United States
(12) Patent Application Publication
(10) Pub. No.: US 2025/0083783 A1
(43) Pub. Date: Mar. 13, 2025

(54) WEARABLE INFLATABLE FLOTATION DEVICE

(71) Applicant: NEOMARE LTD., Kfar Hess (IL)

(72) Inventors: Noam SHANI, Kokhav Yair (IL); Omri DAGAN, Kfar Hess (IL); Eldad EREL, Deux Plateux Abidjan (CI)

(73) Assignee: NEOMARE LTD., Kfar Hess (IL)

(21) Appl. No.: 18/723,472

(22) PCT Filed: Dec. 28, 2022
(86) PCT No.: PCT/IL2022/051402

§ 371 Date: Jun. 24, 2024

Related U.S. Application Data
(60) Provisional application No. 63/296,512, filed on Jan. 5, 2022.

(51) Int. Cl. B63C 9/18; B63C 9/13; B63C 9/15; C01B 3/06

(52) U.S. Cl. CPC B63C 9/18; B63C 9/15; C01B 3/065; B63C 2009/131

(57) ABSTRACT

Described herein are inflatable wearable devices comprising: a reaction container having an expandable bladder, a dry powder compartment and a liquid compartment with a removable barrier between the compartments, the expandable bladder being connected to at least one of the dry powder compartment or the liquid compartment, and wherein the dry powder compartment comprises a mixture of an ionic hydride and a borohydride, and wherein the liquid compartment comprises an aqueous solution comprising a foam forming agent, and wherein upon removal of the barrier between the compartments, the aqueous solution contacts the mixture of an ionic hydride and a borohydride, thereby forming hydrogen gas foam.

### CROSS REFERENCE TO RELATED APPLICATIONS

Benefit is claimed to U.S. Provisional Patent Application No. 63/296,512, filed Jan. 5, 2022, the contents of which are incorporated by reference herein in their entirety.

### FIELD

Provided herein are wearable flotation devices and methods for their manufacture.

### BACKGROUND

Drowning occurs when an individual is submerged in water and inhales water, causing injury or death. Drowning is a common cause of death, especially among young people and children. Authorities estimate about 370,000 deaths per year worldwide as a result of drowning.

Drowning frequently occurs in bodies of water such as pools, lakes, seas and oceans, and can occur to anyone, even to people who are experienced swimmers. In seas and oceans, currents and waves can unexpectedly disorient swimmers, causing swimmers to panic and/or drown.

Personal flotation devices are wearable devices, secured to a wearer, designed to provide sufficient buoyancy to keep wearers afloat. A life jacket is a common type of personal flotation device commonly available to seafarers. Personal flotation devices are typically formed of fabric and secured to a wearer using straps and clips. Such devices typically use a plastic foam such as polyurethane, polyvinyl chloride or polyethylene to provide buoyancy. Such devices, while effective, are often bulky and uncomfortable. Due to their size, people involved in marine activities which require intense activity or freedom of motion, such as open-water swimming, are reluctant to wear such devices.

Personal flotation devices have been described in U.S. Pat. Nos. 5,823,840; 3,977,031; and 6,066,017; as well as in PCT Application Publications WO 02/098728, WO 2012/034185, WO 2017/011783; and in Australian Patent Number 499141, incorporated herein by reference.

### SUMMARY

Described herein are inflatable wearable devices comprising: a reaction container having an expandable bladder, a dry powder compartment and a liquid compartment with a removable barrier between the compartments, the expandable bladder being connected to at least one of the dry powder compartment or the liquid compartment, and wherein the dry powder compartment comprises a mixture of an ionic hydride and a borohydride, and wherein the liquid compartment comprises an aqueous solution comprising a foam forming agent, and wherein upon removal of the barrier between the compartments, the aqueous solution contacts the mixture of an ionic hydride and a borohydride, thereby forming hydrogen gas foam.

The foregoing and other objects, features, and advantages will become more apparent from the following detailed description, which proceeds with reference to the accompanying figures.

### BRIEF DESCRIPTION OF THE DRAWINGS

FIG. 1 depicts a depicts an inflatable wearable device in the form of a wristband, comprising an inflation device according to an embodiment; and

FIG. 2 depicts an inflation device which can be used as part of an inflatable wearable device to provide buoyancy to the wearer.

### DETAILED DESCRIPTION

### I. Terms

Unless otherwise noted, technical terms are used according to conventional usage. Unless otherwise explained, all technical and scientific terms used herein have the same meaning as commonly understood by one of ordinary skill in the art to which this disclosure belongs. The singular terms “a,” “an,” and “the” include plural referents unless context clearly indicates otherwise. Similarly, the word “of” is intended to include “and” unless the context clearly indicates otherwise. It is further to be understood that all base sizes or amino acid sizes, and all molecular weight or molecular mass values, given for nucleic acids or polypeptides are approximate, and are provided for description. Although methods and materials similar or equivalent to those described herein can be used in the practice or testing of this disclosure, suitable methods and materials are described below. The term “comprises” means “includes.” The abbreviation, “e.g.” is derived from the Latin exempli gratia, and is used herein to indicate a non-limiting example. Thus, the abbreviation “e.g.” is synonymous with the term “for example.”

In case of conflict, the present specification, including explanations of terms, will control. In addition, all the materials, methods, and examples are illustrative and not intended to be limiting.

### II. Overview of Several Embodiments

Provided herein are wearable devices, comprising reagents stored in a plurality of compartments, which when combined, form hydrogen gas entrapped in a foam. The hydrogen gas foam (a combination of hydrogen gas, and a liquid, in which the liquid forms bubbles filled with hydrogen gas) fills a bladder which provides buoyancy to the wearer of the device, assisting the wearer in flotation in a body of water, for example, in a sea or ocean. The combination of the reagents can be performed by a wearer of the device when in need of flotation assistance by removing a barrier between the plurality of compartments, thereby initiating a reaction to form hydrogen gas, thereby filling the bladder quickly, allowing the wearer to float, allowing the wearer to wait for rescue, or to proceed to safety by exiting the body of water.

Previously described personal flotation devices include a solid canister comprising a pressurized gas such as carbon dioxide. When a wearer is in need of flotation assistance, the wearer opens the canister, releasing the pressurized gas into a bladder attached to or incorporated within the flotation device. The bladder provides buoyancy, prevents drowning, and allows the wearer to exit the body of water safely. However, such personal flotation devices are disadvantageous for a number of reasons. To provide buoyancy assistance for a human weighing between 50-100 kilograms, a sufficient amount of gas is required. The amount of gas must be carried in a pressurized canister, which itself must be massive enough to withstand the pressure of the gas. This adds weight and volume the personal flotation device. The additional weight and volume of the personal flotation device reduces user compliance and may prevent a user from using the device during activities such as swimming. Furthermore, pressurized gas containers are relatively expensive. Pressurized gas containers are solid and inflexible, and are typically made in a cylindrical shape. Such containers are difficult to attach comfortably to the contours of a human body.

The wearable devices described herein overcome the disadvantages associated with previously described personal flotation devices. The wearable devices described herein comprise reagents which when combine form hydrogen gas (H₂). The hydrogen gas fills a bladder, providing buoyancy. According to the ideal gas law, and assuming that gases act as ideal gases, the volume of the filled bladder at a given temperature is proportional to the number of molecules of the gas. Hydrogen gas, having a low molecular weight (of about 2 grams per mole) provides much more buoyancy per weight relative to air (about 29 grams per mole) or carbon dioxide (about 44 grams per mole). This makes hydrogen a more attractive gas for a wearable device to provide buoyancy because the wearer needs to generate only a small amount (by weight) of hydrogen gas relative to other common gases. As a result, the amount of starting material required is less.

Although hydrogen gas is attractive as a gas for providing buoyancy, it has significant drawbacks. Hydrogen gas is highly flammable and is flammable when present even in low amounts such as 4% in an air-hydrogen mixture.

Despite the drawbacks associated with hydrogen gas, the inventors have found that hydrogen gas can be used to form a buoyant hydrogen gas foam which, when contained in a bladder, can provide buoyancy to a wearable device worn by a wearer, without the risks of flammability and combustibility associated with hydrogen gas in non-foam form.

Wearable devices described herein may be in the form of a wristband, bracelet, hip pouch, or jacket. Most preferable embodiments relate to a wristband which comprises a stretchable, elastic material that can be used to secure the wristband to a wearer's hand and remove the wristband when not in use. The device may optionally comprise an adjustable strap to adjust the device to be securely worn by a wearer. Preferably the device is compact and safe for use for wearers.

Devices described herein are reliable and can be deployed successfully each time the wearer initiates the chemical reaction described herein, to produce hydrogen gas foam within the bladder. The devices preferably comprise sufficient starting material to form 8 liters of hydrogen gas foam at 20° C., thereby providing sufficient buoyancy to the wearer.

Preferably, devices described herein are single-use, disposable safety devices. In other words, after deployment of the chemical reaction to form hydrogen gas foam, and after the wearer is brought to safety, the wearable device is removed from the wearer and is disposed of.

Preferably, wearable devices described herein can be safely used in a variety of conditions and temperatures. The devices are preferably waterproof and can be immersed in water without automatic activation of the chemical reaction to form hydrogen gas foam upon immersion of the device in water without the wearer's intentional deployment and allow for deployment of the device (formation of the hydrogen gas foam) in a variety of conditions, including while the device is submersed in water. The wearable devices are preferably stable (are not automatically activated without the wearer's intent) at a variety of temperatures, from −5° C. to 50° C. The devices described herein can be easily activated by a wearer and can provide hydrogen gas foam at a variety of temperature conditions from −5° C. to 50° C.

According to an embodiment, hydrogen gas foam is formed by the wearer by combining an aqueous solution with an ionic hydride, borohydride or combination thereof. The ionic hydride is preferably aluminum hydride AlH₃, magnesium hydride MgH₂, or lithium aluminum hydride LiAlH₄. The borohydride is preferably lithium borohydride LiBH₄, aluminum borohydride Al(BH₄)₃ or sodium borohydride LiAlH₄. Optionally, the hydrogen gas forming agent used is a mixture of an ionic hydride with a borohydride. Optionally, the ratio by weight of ionic hydride to borohydride is between 1:100 and 1:4. The ionic hydride is most preferably lithium aluminum hydride LiAlH₄. The borohydride is most preferably sodium borohydride. Preferably, the ionic hydride LiAlH₄ is present in amount of 3% by weight and the borohydride LiAlH₄ is present in an amount of 97% by weight of the solid to be reacted with water.

To form hydrogen gas foam, the ionic hydride and/or borohydride is preferably contacted with water to form hydrogen gas. The water is preferably mixed (in solution or suspension) with other agents (foam forming agents) to form a foam upon contact of the ionic hydride or borohydride with the water.

According to an embodiment, the wearable device comprises a sufficient amount of water, foam forming agent, and ionic hydride or borohydride to form an amount of hydrogen gas foam sufficient to provide buoyancy to a wearer weighing 80 kg at 20° C. Optionally, the amount of hydrogen gas foam is sufficient to fill a bladder to a volume of between 5 and 10 liters at atmospheric pressure and at 20° C.

Preferably, the amount of ionic hydride or borohydride present in the wearable device is between 2 and 10 grams, preferably 3-5 grams. The amount of water present in a foam forming solution in the wearable device for reacting with the ionic hydride or borohydride is preferably between 5-15 grams, preferably between 6 and 10 grams. The amount of hydrogen gas formed by the reaction of the ionic hydride or borohydride with water in the solution is sufficient to form a hydrogen gas-based foam having a volume of about 8 L at 20° C.

According to an embodiment, an acidifying agent is added to the aqueous solution to assist in formation of hydrogen gas upon reaction of water with an ionic hydride and/or borohydride. Optionally, the acidifying agent is a weak acid. Optionally, the acidifying agent is citric acid or sulfamic acid. Optionally, the acidifying agent is added in an amount of between 1% to 7% by weight of the aqueous solution.

According to an embodiment, a foam forming agent is added to the aqueous solution to form foam upon formation of hydrogen gas upon initiation of the reaction with ionic hydride or borohydride. The foam forming agent may be a surfactant or a detergent. Optionally, the foam forming agent is selected from the group consisting of: ethylene glycol, sodium alkyl benzenesulfonate, and sulfanol. The foam forming agent is most preferably sulfanol. The foam forming agent may be present in the solution in an amount of between 1% to 5% by weight, preferably 2%-3% by weight of the aqueous solution.

According to an embodiment, the aqueous solution further comprises a sodium, potassium or ammonium salt of phosphoric acid. Preferably, the salt is sodium trifluorophosphate. Preferably, the salt is present in an amount of between 0.5% and 7% by weight, preferably 3% to 5% by weight.

According to an embodiment, the aqueous solution further comprises a foam stabilizing agent. Preferably, the foam stabilizing agent is selected from the group consisting of diethylene glycol, propylene glycol and cyclohexanol. Optionally, the foam stabilizing agent is cyclohexanol, and is added in an amount of between 1% and 3% by weight of the aqueous solution. Optionally, the aqueous solution further comprises aluminum potassium sulfate, preferably in an amount between 0.01% to 0.1% by weight of the aqueous solution.

According to an embodiment, the aqueous solution further comprises a bicarbonate. A bicarbonate may be, for example sodium or potassium bicarbonate. The bicarbonate may release carbon dioxide gas to reduce the flammability of the hydrogen gas foam formed. Preferably, the bicarbonate is present in an amount of between 1% and 4% by weight of the aqueous solution.

Optionally a fragrance is included in the solution. The fragrance may be an aromatic oil such as pine oil. The fragrance may be present in an amount of between 0.001% and 0.01% by weight.

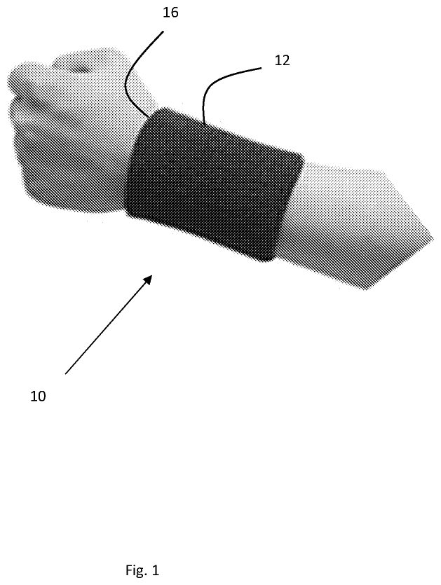

Reference is made to FIG. 1, which depicts a wearable device in the form of a wristband 10. wristband 10 has a strap 12. Strap 12 may be made of a durable fabric such as nylon webbing, and may contain ornamental elements for decoration. Strap 12 has a distal end 16.

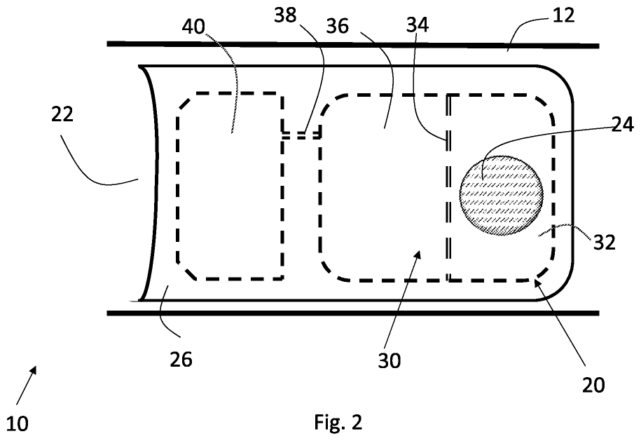

Wristband 10 further has an inflation device 20, which is shown in detail in FIG. 2. Optionally, inflation device 20 is present within wristband 10 and is not seen externally to a viewer when wristband 10 is being worn by a user, as in FIG. 1. Reference is now made to FIG. 2 which depicts inflation device 20 showing the internal elements. Inflation device 20 has an outer cover 26, securing elements of the device within a pocket formed between cover 26 and strap 12. Cover 26 is equipped with an activation indicator 24 which can be colored a different color than cover 26, and/or may have a different texture than the rest of cover 26 to allow a user to tactically identify activation indicator 24. Activation indicator 24 may be configured on the internal surface of strap 12 or on an external surface of the strap. An aperture 22 is formed between cover 26 and strap 12.

Inflation device 20 has a reaction container 30, which is composed of a liquid compartment 32, a dry powder compartment 36, and an expandable bladder 40. A barrier 34 is form between liquid compartment 32 and dry powder compartment 36. Reaction container 30 is secured to strap 12. Dry powder compartment 36 is connected via a one-way valve 38 to expandable bladder 40. As shown, activation indicator 24 is configured to be located on top of liquid compartment 32. Dry powder compartment 36 and liquid compartment 32 may be together formed from a single sleeve, formed from a liquid-impermeable, flexible thin film polymeric material, for example polyvinyl chloride, and separated from each other by barrier 34. Expandable bladder 40 may be formed from an expandable polymeric material and may be configured as an expandable balloon. Alternatively, bladder 40 may be in the form of a bag in a folded state. The bag may be configured to unfold and expand upon inflation. Dry powder compartment 36 is filled with a powder, which upon contact with water, forms hydrogen gas, for example an ionic hydride or borohydride. Liquid compartment 32 comprises water, and a foam foaming agent, and optionally other ingredients to be discussed below. Barrier 34 comprises an adhesive configured so that application of pressure on liquid compartment 32 opens the adhesive, thereby breaking barrier 34 and allowing flow of a liquid between liquid compartment 32 and dry powder compartment 36.

When wristband 10 is worn, it appears to be an ornamental, or sport wristband. It is flexible and can conform to the shape of the wearer's wrist, without interfering with a wearer's activities, including during water-based activities such as swimming, sailing, and surfing. Preferably, the profile of wristband does not extend radially more than 1 cm from the arm of the wearer. Reaction container is concealed between strap 12 and cover 26 and is not visible. Preferably, wristband 10 weighs less than 50 grams.

If a wearer believes he or she is in danger of drowning and wishes to activate the device, the wearer locates activation indicator 24 and applies pressure to it, thereby separating adhesive of barrier 34 and allowing liquid to flow from liquid compartment 32 to dry powder compartment 36. Upon contact of liquid in the liquid compartment 32, comprising water and a foam forming agent, with powder in dry powder compartment 36, comprising a hydrogen gas forming agent such as an ionic hydride and/or borohydride, hydrogen gas is formed through a chemical reaction. Pressure builds within dry powder compartment 36 and liquid compartment 32 as hydrogen gas continues to form from the reaction forming hydrogen gas, and hydrogen gas foam flows out of one-way valve 38 to expandable bladder 40. As expandable bladder 40 fills with hydrogen gas and hydrogen gas foam, it expands in the direction of aperture 22 and continues to expand. Bladder 40, expands out from aperture 22 and out from distal end 16 (FIG. 1). Upon completion of the chemical reaction, expandable bladder 40 is filled and provides buoyancy to wearer of wristband 10.

Preferably, reaction container 30 is airtight and watertight as it does not allow air to flow in or hydrogen gas foam or hydrogen gas to flow out of it. Furthermore, it can be immersed in water, such as sea water, while a user is wearing it without allowing water from outside of reaction container 30 to penetrate and enter liquid compartment 32 and dry powder compartment 36 or the expandable bladder 40.

One method of combining contents of a dry powder compartment and a liquid compartment has been described with reference to FIGS. 1 and 2, however, other methods for combining contents of a dry powder compartment and a liquid compartment can also be used. For example, an exterior part of a wearable device may comprise a pull-tab, having an easily locatable ring at its proximal end, and at its distal end be connected to a wire. The wire may be configured to open a barrier between a liquid compartment and a dry powder compartment, thereby allowing flow of the liquid into the dry powder compartment. Alternatively, the liquid compartment may be a sealed polymeric bag contained within a larger bag, which is the dry powder compartment. The liquid compartment may be configured to rupture under pressure. To combine the contents of the liquid compartment with the contents of a dry powder compartment, a wearer may apply pressure to the liquid compartment, thereby rupturing the bag, and allowing liquid to flow from the bag into the dry powder compartment. Foam formed from the reaction may then flow into a bladder, which is flow-connected to the dry powder compartment.

One embodiment of an inflatable wearable device in the form of a wristband was described in detail with reference to FIGS. 1 and 2. Inflatable wearable devices can be similarly made in the form of a belt configured to be worn around a waist of a wearer, a vest for wearing on a torso of a wearer, or a variety of other wearable devices.

Optionally, the wearable device may be slipped on to the body of the user. Optionally, the wearable device comprises a connector, which may be opened before attaching the wearable device to the user and may be closed to secure the device to the user. The connector may comprise a snap, a zipper, a button, or a clip.

Optionally, the dry powder compartment is sealed after removing air from the compartment, to prevent reaction of dry powder components with gas/water moisture in air before activation of the device.

Additionally described herein are methods for forming a hydrogen gas-containing foam comprising combining a solid mixture of an ionic hydride with a borohydride, and an aqueous solution comprising a foam-forming agent within a reaction chamber flow-connected to an inflatable bladder, thereby forming hydrogen gas-containing foam.

Additionally described herein are methods for providing buoyancy to a flotation device comprising forming a hydrogen gas-containing foam as described above and securing the inflatable bladder to a device. In addition to flotation devices described herein, embodiments of the invention relate to inflatable bladders for a variety of uses. An inflatable bladder comprising a hydrogen gas-containing foam may be used as a lighter-than-air weather balloon to measure atmospheric conditions at high altitudes. Such a weather balloon may be attached to a radiosonde to convey information from high altitude. Another application of an inflatable bladder comprising hydrogen gas-containing foam is for safe storage of hydrogen gas, which can be used in various applications including but not limited to fuel cells.

The following examples are provided to illustrate certain particular features and/or embodiments. These examples should not be construed to limit the disclosure to the particular features or embodiments described.

### EXAMPLES

### Example 1: Fireproof Hydrogen Gas Mixtures

In an attempt to prepare a hydrogen gas bladder for providing buoyancy without risk of explosion associated with hydrogen gas, hydrogen gas was mixed with various types of flame retardant gases. Plastic semi-transparent containers of 10 liters each were filled with hydrogen gas and difluorodibromomethane was tested in weight percentages relative to hydrogen gas of 2, 4, 6, 8, 10, 12, 14 and 16 percent difluorodibromomethane. Similar containers were prepared with tetrafluorodibromoethane in weight percentages relative to hydrogen gas of 2, 4, 6, 8, 10, 12, 14 and 16 percent tetrafluorodibromoethane. The combinations of hydrogen gas and difluorodibromomethane were all flammable, even at the highest percentages of 16%. The combinations of hydrogen gas and tetrafluorodibromoethane, in some experiments, prevented flammability of hydrogen gas at 12%.

Although such combinations were found to be not flammable, the hydrogen gas combination with tetrafluorodibromoethane reduces the buoyancy of the gas mixture relative to using hydrogen gas as the only gas, and also requires a wearer of an inflatable hydrogen gas bladder to carry more starting material to form a non-flammable gas-filled bladder.

### Example 2A: Hydrogen-Gas Forming Agents and Acidic Aqueous Media

In order to test hydrogen-gas forming agents which could be used for rapidly generating hydrogen gas upon combination with water, sodium borohydride was reacted with water.

Distilled water was added to sodium borohydride at room temperature and stirred. No hydrogen gas formation was observed. Aqueous acidic solutions were prepared at various percentages (by weight of acid in solution) and a crystal of sodium borohydride was added to each of the solutions. The reaction mixture was observed to see if gas formation was visible. The results appear in Table 1 below. “Yes” indicates that a reaction was observed, and “No” indicates that no reaction was observed.

TABLE 1

| Acid | 1% | 3% | 5% | 7% |
|---|---|---|---|---|
| Citric Acid | No | Yes | Yes | Yes |
| Oxalic Acid | No | No | No | No |
| Tartaric Acid | No | No | No | No |
| Sulfamic Acid | Yes | Yes | Yes | Yes |

To ensure that gas production would occur at low temperatures, for example if a wearer becomes submerged in icy water, reactions of sodium borohydride with aqueous solutions of sulfamic acid at 10° C. were tested at 1% and 3% concentrations of sulfamic acid. The reaction rate appeared similar to that tested at room temperature. At 0° C., reaction of 1% sulfamic acid solution with sodium borohydride was significantly decreased, whereas 3% sulfamic acid solution was somewhat decreased. The 5% and 7% solutions at 0° C. remained active as at room temperature.

### Example 2B: Hydride and Borohydride Mixtures

In addition to sodium borohydride, other hydride reagents were reacted with water to determine suitability for using in generating hydrogen in an inflatable device for providing buoyancy. Lithium aluminum hydride, upon contact with water, generates hydrogen. However, the reaction is rapid and highly exothermic. Lithium aluminum hydride as a sole agent for producing hydrogen to provide buoyancy would not be suitable because the heat generated would require a special, heat resistant reaction chamber, which would add to the weight of the inflatable device. In addition, the heat generated is a safety hazard to the wearer of the device.

Compositions comprising sodium borohydride as a major component and lithium aluminum hydride as a minor component were prepared as shown in Table 2.

TABLE 2

| Composition | NaBH₄ (percent by weight) | LiAlH₄ (percent by weight) |
|---|---|---|
| 1 | 98 | 2 |
| 2 | 95 | 5 |
| 3 | 90 | 10 |
| 4 | 85 | 15 |

To test the feasibility of these compositions 1-4, they were introduced into water at room temperature and the temperature was checked after the reaction. In all of the reactions, there was a reaction which formed hydrogen gas and the reaction caused a slight increase of temperature, with the temperature increase measured being proportional to the relative percentage of LiAlH₄. Even composition 4, with the highest relative LiAlH₄ percentage, increased the reaction temperature to a temperature of less than 50° C.

An experiment was performed with water at 0° C. and a composition having 25% LiAlH₄ and 75% NaBH₄. The resulting reaction mixture also remained less than 50° C.

### Example 3: Foam Forming Agents

An attempt was made to reduce flammability of hydrogen gas by forming a hydrogen-gas based foam. The foam, formed by a foam forming-liquid, consists of small bubbles of hydrogen gas, separated from each other and from air by a thin layer of form forming liquid. The foam was intended to have a high foam forming capacity, be long lasting, and should not release free gas from the foam. Preferably the foam is designed to be substantially uniform in bubble size, chemically inert, non toxic to humans and to the environment, and not flammable. These qualities were considered desirable for a hydrogen-based foam to serve as a basis for use in filling an inflatable wearable device.

The following foam forming agents were chosen as potential for use in the reaction: A. ethylene glycol, B. sodium alkyl benzenesulfonate, and C. sulfanol (hydrogen thioperoxide).

Aqueous solutions were prepared with sulfamic acid dissolved in water, and foam forming agents (A, B, or C) in amounts of 1%, 2%, 3%, 4% and 5% by weight. A mixture of having 3% LiAlH₄ and 97% NaBH₄ was added to the respective solutions at room temperature. The volume of foam was measured in a graduated cylinder.

Foam was formed upon addition of the hydride/borohydride mixture to all of the solutions containing foam forming agents A, B, or C at 2% and above. However, the most advantageous foam forming agent was sulfanol. Solutions containing sulfanol provided foams having between about 15% more volume than agents A and B at similar concentrations. Similar testing was attempted at 0° C. with sulfanol, and the foam volume was lower. When the concentration of sulfanol was increased to 3%, the volume was increased even at low temperature.

When sulfanol was used as a foam forming agent, there was a certain lack of homogeneity of the size of bubbles in the foam formed, based on visual observation. An attempt was made to make uniform bubble size, and ideally, small bubbles.

Sodium, potassium and ammonium salts of phosphoric acid, including phosphates, metaphosphates and pyrophosphates were added to increase uniformity of bubble size within the foams formed. No significant difference was found between sodium, potassium and ammonium salts. Three salts were chosen because of their relatively low cost: sodium tripolyphosphate, diammonium phosphate and sodium hexametaphosphate in amounts ranging between 0.5% and 7% were found to be effective.

### Example 4: Foam Stabilizing Agents

In order to preserve the hydrogen foam in foam form, a number of foam stabilizing agents were tested, including diethylene glycol, propylene glycol, and cyclohexanol, in concentrations of 1%, 2% and 3% by weight in aqueous solution. Foam was formed and its volume measured at formation in graduated cylinders at 6 hours, and daily until a week following formation. Cyclohexanol at 1 and 2% retained the foam with little to no change in volume for week. The diethylene glycol and propylene glycol stabilizing agents, even at 3%, allowed the foam to retain its volume for about 2-3 days. Cyclohexanol as a foam stabilizing agent at an amount of 1-3% was shown to be beneficial for stabilizing foam even at colder temperatures.

### Example 5: Enhanced Hydrogen Trapping

Foams described in Example 4 did not release hydrogen for extended periods of time, as long as 7 days. This is sufficient for many applications of foams and devices described herein. However, it was found that between 7 and 14 days, such foams did release small amounts of hydrogen. Two agents were tested to add to solutions described in example 4: Pectin, and aluminum potassium sulfate. Aluminum potassium sulfate was successful in preventing release of hydrogen from foam at room temperature when added at a concentration of 0.01% by weight until day 18 from formation of the foam. Addition of aluminum potassium sulfate at a concentration of 0.05% by weight ensures that the foam retains its hydrogen content for 21 days.

According to an embodiment, described herein is an inflatable wearable device comprising: a reaction container having an expandable bladder, a dry powder compartment and a liquid compartment with a removable barrier between the compartments, the expandable bladder being connected to at least one of the dry powder compartment or the liquid compartment, and wherein the dry powder compartment comprises a mixture of an ionic hydride and a borohydride, and wherein the liquid compartment comprises an aqueous solution comprising a foam forming agent, and wherein upon removal of the barrier between the compartments, the aqueous solution contacts the mixture of an ionic hydride and a borohydride, thereby forming hydrogen gas foam. Optionally, the aqueous solution further comprises an acidifying agent. Optionally, the acidifying agent is present in an amount of between 1% to 7% by weight of the aqueous solution. Optionally, the acidifying agent comprises sulfamic acid. Optionally, the foam forming agent is a surfactant or a detergent. Optionally, the foam forming agent is selected from the group consisting of: ethylene glycol, sodium alkyl benzenesulfonate, and sulfanol, preferably sulfanol. Optionally, the foam forming agent is present in a concentration of between 1 to 5% by weight of the aqueous solution. Optionally, the aqueous solution further comprises an acidifying agent. Optionally, the acidifying agent is sulfamic acid. Optionally, the acidifying agent is present in a concentration of between 1% and 7% by weight of the aqueous solution. Optionally, the aqueous solution further comprises a sodium, potassium or ammonium salt of phosphoric acid. Optionally, the sodium salt of phosphoric acid is sodium trifluorophosphate. Optionally, the aqueous solution further comprises a foam stabilizing agent. Optionally, the foam stabilizing agent is selected form the group consisting of diethylene glycol, propylene glycol and cyclohexanol. Optionally, the foam stabilizing agent is present in a concentration of between 1% and 3% by weight of the aqueous solution. Optionally, the aqueous solution further comprises a bicarbonate. Optionally, the aqueous solution further comprises aluminum potassium sulfate. Optionally, aluminum potassium sulfate is present in an amount of 0.01% to 0.1% by weight of the aqueous solution. Optionally, the ratio between ionic hydride to borohydride is between 1:100 to 1:4 by weight Optionally, the combination of ionic hydride and borohydride mixture with the aqueous solution causes a reaction which forms at least 8 L of hydrogen gas foam at 20° C. Optionally, the amount of mixture of ionic hydride or borohydride in the device is between 2 and 10 grams, preferably between 3 and 5 grams. Optionally, the amount of aqueous solution is between 5 and 15 grams. Optionally, the inflatable wearable device further comprises at least one strap and at least one connector configured to secure the strap around a part of a human body. Optionally, the inflatable wearable device is in the form of a wristband. Optionally, the foam retains its volume at room temperature until at least 7 days after formation. Optionally, the barrier can be removed by applying pressure to one of the dry powder compartment or the liquid compartment.

Further described herein is a method for forming a hydrogen gas-containing foam comprising combining a mixture of an ionic hydride with a borohydride, with water and with a foam-forming agent. Optionally, the method further comprises combining the mixture with water and with a foam-forming agent within a closed container connected to an inflatable bladder.

Further described herein is a method for providing buoyancy to a user involved in a water activity comprising: providing an inflatable device to a user involved in a water activity, the inflatable device comprising a reaction container having an expandable bladder, a dry powder compartment and a liquid compartment with a removable barrier between the compartments, the expandable bladder being connected to at least one of the dry powder compartment or the liquid compartment, and wherein the dry powder compartment comprises a mixture of an ionic hydride and a borohydride, and wherein the liquid compartment comprises an aqueous solution comprising a foam forming agent, and, removing the barrier between the compartments, thereby contacting the aqueous solution with the mixture of an ionic hydride and a borohydride, thereby forming hydrogen gas foam.

Further described herein is an inflatable bladder comprising a reaction container having a dry powder compartment and a liquid compartment with a removable barrier between the compartments, the expandable bladder being connected to at least one of the dry powder compartment or the liquid compartment, and wherein the dry powder compartment comprises a mixture of an ionic hydride and a borohydride, and wherein the liquid compartment comprises an aqueous solution. Optionally, the reaction container further comprises a foam-forming agent.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

1. An inflatable wearable device comprising:
a reaction container having an expandable bladder, a dry powder compartment and a liquid compartment with a removable barrier between the compartments, the expandable bladder being connected to at least one of the dry powder compartment or the liquid compartment, and wherein the dry powder compartment comprises a mixture of an ionic hydride and a borohydride, and wherein the liquid compartment comprises an aqueous solution comprising a foam forming agent, and wherein upon removal of the barrier between the compartments, the aqueous solution contacts the mixture of an ionic hydride and a borohydride, thereby forming hydrogen gas foam.

2. The inflatable wearable device according to claim 1 wherein the aqueous solution further comprises an acidifying agent.

3-5. (canceled)

6. The inflatable wearable device according to claim 1 wherein the foam forming agent is selected from the group consisting of: ethylene glycol, sodium alkyl benzenesulfonate, and sulfanol.

7. (canceled)

8. The inflatable wearable device according to claim 1 wherein the foam forming agent is present in a concentration of between 1 to 5% by weight of the aqueous solution.

9. (canceled)

10. (canceled)

11. The inflatable wearable device according to claim 2 wherein the acidifying agent is present in a concentration of between 1% and 7% by weight of the aqueous solution.

12. The inflatable wearable device according to claim 1 wherein the aqueous solution further comprises a sodium, potassium or ammonium salt of phosphoric acid.

13. (canceled)

14. The inflatable wearable device according to claim 1 wherein the aqueous solution further comprises a foam stabilizing agent.

15. The inflatable wearable device according to claim 14 wherein the foam stabilizing agent is selected form the group consisting of diethylene glycol, propylene glycol and cyclohexanol.

16. (canceled)

17. The inflatable wearable device according to claim 1, wherein the aqueous solution further comprising a bicarbonate.

18. The inflatable wearable device according to claim 1, wherein the aqueous solution further comprises aluminum potassium sulfate.

19. The inflatable wearable device according to claim 18 wherein aluminum potassium sulfate is present in an amount of 0.01% to 0.1% by weight of the aqueous solution.

20. The inflatable wearable device according to claim 1 where the ratio between ionic hydride to borohydride is between 1:100 to 1:4 by weight.

21. The inflatable wearable device according to claim 1 wherein the combination of ionic hydride and borohydride mixture with the aqueous solution causes a reaction which forms 8 L of hydrogen gas foam at 20° C.

22. The inflatable wearable device according to claim 1 wherein the amount of mixture of ionic hydride or borohydride in the device is between 2 and 10 grams, preferably between 3 and 5 grams.

23. The inflatable wearable device according to claim 22 wherein the amount of aqueous solution is between 5 and 15 grams.

24. The inflatable wearable device according to claim 1 comprising at least one strap and at least one connector configured to secure the strap around a part of a human body.

25. The inflatable wearable device according to claim 24 in the form of a wristband.

26. (canceled)

27. The inflatable wearable device according to claim 1 wherein the barrier can be removed by applying pressure to one of the dry powder compartment or the liquid compartment.

28. (canceled)

29. (canceled)

30. A method for providing buoyancy to a user involved in a water activity comprising:
providing an inflatable device to a user involved in a water activity, the inflatable device comprising a reaction container having an expandable bladder, a dry powder compartment and a liquid compartment with a removable barrier between the compartments, the expandable bladder being connected to at least one of the dry powder compartment or the liquid compartment, and wherein the dry powder compartment comprises a mixture of an ionic hydride and a borohydride, and wherein the liquid compartment comprises an aqueous solution comprising a foam forming agent, and,
removing the barrier between the compartments, thereby contacting the aqueous solution with the mixture of an ionic hydride and a borohydride, thereby forming hydrogen gas foam.

31. An inflatable bladder comprising a reaction container having a dry powder compartment and a liquid compartment with a removable barrier between the compartments, the expandable bladder being connected to at least one of the dry powder compartment or the liquid compartment, and wherein the dry powder compartment comprises a mixture of an ionic hydride and a borohydride, and wherein the liquid compartment comprises an aqueous solution.

32. The inflatable bladder according to claim 31 wherein the reaction container further comprises a foam-forming agent.
